(19) United States
(12) Patent Application Publication
(10) Pub. No.: US 2011/0074740 A1
(43) Pub. Date: Mar. 31, 2011

(54) Digital tablet for battery-free wireless pointer device and power supply method of the digital tablet for battery-free wireless pointer device

(75) Inventor: Chih Min Liu, Taipei (TW)

(73) Assignee: KYE SYSTEMS CORP., Taipei (TW)

(21) Appl. No.: 12/588,939

(22) Filed: Nov. 3, 2009

(30) Foreign Application Priority Data
Sep. 30, 2009 (TW) 098133309

(51) Int. Cl. G06F 3/038; G06F 3/033

(52) U.S. Cl. 345/179; 345/211

(57) ABSTRACT

A digital tablet for battery-free wireless pointer device and a power supply method of the digital tablet for battery-free wireless pointer device are related to a battery-free wireless pointer device and a digital tablet used in combination. The wireless pointer device includes a power supply circuit and an induction circuit. The digital tablet includes a signal processing circuit, a control circuit, a first antenna loop, and a plurality of second antenna loops. Here, the control circuit is adapted to selectively enable the second antenna loops.

### CROSS-REFERENCE TO RELATED APPLICATIONS

This non-provisional application claims priority under 35 U.S.C. §119(a) on Patent Application No(s). 098133309 filed in Taiwan, R.O.C. on Sep. 30, 2009, the entire contents of which are hereby incorporated by reference.

### BACKGROUND

1. Field of Invention

The present invention relates to an input device, and more particularly to using the electromagnetic resonance, a digital tablet for battery-free wireless pointer device and power supply method of the digital tablet for battery-free wireless pointer device and assembly.

2. Related Art

Currently, every commercially available digital tablet is used in combination with a wireless pointer device. When the wireless pointer device contacts the digital tablet, the wireless pointer device generates an electromagnetic field, so that the digital tablet is enabled to calculate a current coordinate location of the wireless pointer device by magnetic coupling and transfer the coordinate location to a computer end.

The electric power required for the operation of the wireless pointer device is usually provided in the following two manners: one is through a disposable battery and the other is through electromagnetic resonance. As for the manner of using a disposable battery, the battery needs to be frequently replaced for the wireless pointer device, causing great inconvenience and environment problems for a user. Therefore, electromagnetic resonance is currently the most suitable power supply manner.

However, in the existing technologies regarding power supply through electromagnetic resonance for the wireless pointer device and the digital tablet, the digital tablet has to transmit a great magnetic field which is then received by the wireless pointer device. After the wireless pointer device accumulates a certain amount of energy, the wireless pointer device radiates the energy to the digital tablet. This manner has problems such as high power consumption of the digital tablet, complicated circuit designs, high cost, and high electromagnetic field radiations.

Therefore, it is the problem in urgent need of solutions to reduce power consumption of the digital tablet, simplify circuit designs, decrease cost prices, and lower electromagnetic field radiations in the industry.

### SUMMARY

Accordingly, the present invention is a for battery-free wireless pointer device and power supply method of the digital table for battery-free wireless pointer device, so as to solve the problems caused by power supply through electromagnetic resonance in the prior art.

In order to achieve the above objectives, the present invention provides a digital tablet for battery-free wireless pointer device, which comprises a battery-free wireless pointer device and a digital tablet used in combination.

The digital tablet at least comprises a signal processing circuit, a first antenna loop, and a plurality of second antenna loops.

The signal processing circuit is used for generating a frequency signal and calculating a current coordinate location of the battery-free wireless pointer device according to an induction signal sent by the battery-free wireless pointer device.

The first antenna loop forms an induction zone for inducing the battery-free wireless pointer device, so as to induce the battery-free wireless pointer device to receive the induction signal wirelessly.

The plurality of second antenna loops is located on the induction zone for transmitting the frequency signal selectively according to the coordinate location.

The digital tablet further comprises a control circuit.

The control circuit is used for selecting the second antenna loop located on the coordinate location among the second antenna loops to transmit the frequency signal.

When the digital tablet and the battery-free wireless pointer device are signal-connected, for the second antenna loops, the control circuit only enables the second antenna loop located on the coordinate location, so that only the second antenna loop located on the coordinate location transmits the frequency signal.

Here, the battery-free wireless pointer device is a wireless cursor pen or a wireless mouse.

### BRIEF DESCRIPTION OF THE DRAWINGS

The present invention will become more fully understood from the detailed description given herein below for illustration only, and thus are not limitative of the present invention, and wherein:

FIG. 1 is a schematic view showing the appearance of a digital tablet for battery-free wireless pointer device according to an embodiment of the present invention;

FIG. 2 is a schematic view of a circuit structure of the digital tablet for battery-free wireless pointer device according to an embodiment of the present invention;

FIG. 3 is a schematic view of a configuration relation between a first antenna loop and a plurality of second antenna loops according to an embodiment;

FIG. 4 is a schematic view of a configuration relation between a first antenna loop and a plurality of second antenna loops according to another embodiment;

FIG. 5 is a schematic view of a digital tablet according to an embodiment;

FIG. 6 is a schematic view of a digital tablet according to another embodiment; and

FIG. 7 is a flow chart of a power supply method for the digital tablet for battery-free wireless pointer device according to an embodiment of the present invention.

### DETAILED DESCRIPTION

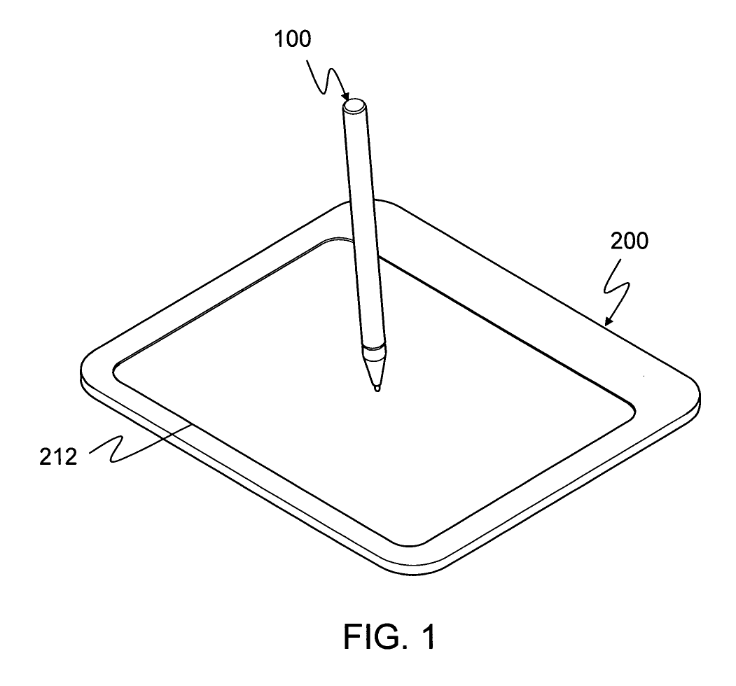

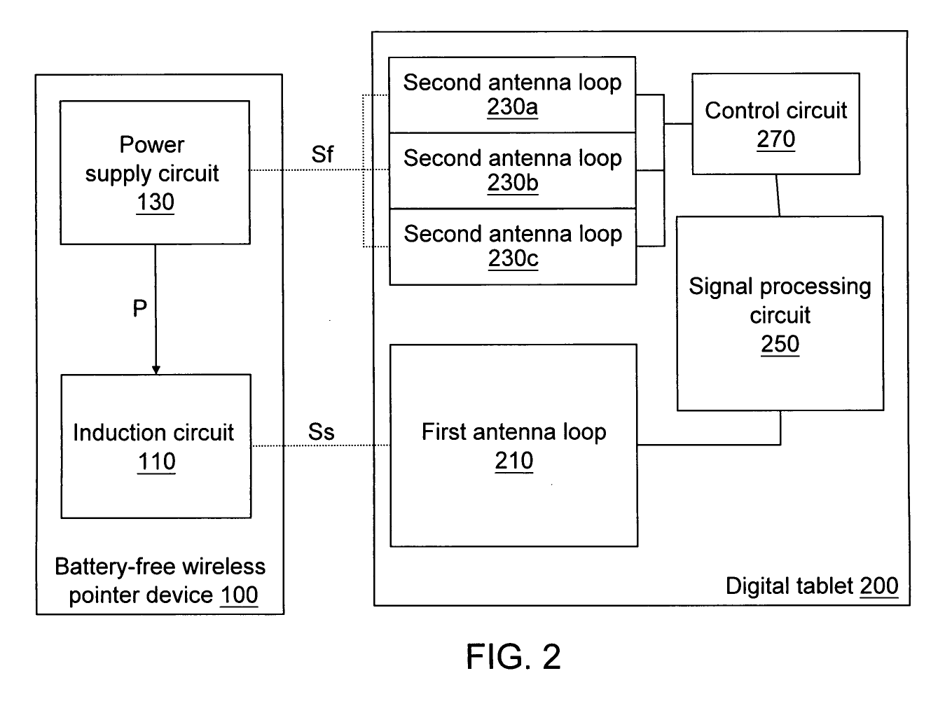

Referring to FIGS. 1, 2, 3, and 4, a digital tablet for battery-free wireless pointer device comprises a battery-free wireless pointer device 100 and a digital tablet 200. The battery-free wireless pointer device 100 and the digital tablet 200 are used in combination.

The battery-free wireless pointer device 100 at least comprises a power supply circuit 130 and an induction circuit 110.

The power supply circuit 130 utilizes a plurality of induction coils to receive a frequency signal Sf sent by the digital tablet 200 wirelessly, and forms mutual electromagnetic resonance through the frequency signal Sf to produce a required electric power P.

The induction circuit 110 receives the electric power P produced by the power supply circuit 130, generates an induction signal Ss, and transmits the induction signal Ss to the digital tablet 200.

The power supply circuit 130 may comprise a plurality of induction coils and a rectifier circuit. On receiving the frequency signal Sf sent by the digital tablet 200 at the same time, the induction coils present the same frequency, thereby causing an electromagnetic resonance effect to generate an energy signal to the rectifier circuit. The rectifier circuit then utilizes the energy signal to produce the required electric power P for the operation of the battery-free wireless pointer device 100.

The induction circuit 110 may comprise an oscillation circuit and an induction coil. The operation of the oscillation circuit is maintained through the electric power P generated by the power supply circuit 130, so as to generate an induction signal. The induction coil then transmits an induction signal Ss generated by the oscillation circuit to the digital tablet 200. An electronic circuit structure of the power supply circuit 130 or the induction circuit 110 is not the subject matter of the present invention, so the details thereof may not be described herein.

The digital tablet 200 at least comprises a signal processing circuit 250, a first antenna loop 210, and a plurality of second antenna loops 230a, 230b, and 230c.

The signal processing circuit 250 is used for generating a frequency signal Sf and calculating a current coordinate location of the battery-free wireless pointer device 100 according to the induction signal Ss sent by the battery-free wireless pointer device 100.

The first antenna loop 210 forms an induction zone 212 for inducing the battery-free wireless pointer device 100, so as to induce the battery-free wireless pointer device 100 to receive the induction signal Ss wirelessly.

The plurality of second antenna loops 230a, 230b, and 230c is located on the induction zone 212 for transmitting the frequency signal Sf selectively according to the coordinate location. Although three second antenna loops 230a, 230b, and 230c are depicted in the accompanying drawings, the number of the second antenna loops is not limited herein. In related fields of the present invention, persons of ordinary skill in the art may definitely adopt two, four, or above five second antenna loops to implement the present invention in addition to the design of three second antenna loops.

The first antenna loop 210 may comprise an induction antenna loop of x-axis and y-axis coordinates.

For example, when the battery-free wireless pointer device 100 approaches a location disposed with the second antenna loop 230a of the digital tablet 200, a coordinate location of the battery-free wireless pointer device 100 is obtained through the induction signal Ss received by the first antenna loop 210, and the second antenna loop 230a is enabled to transmit the frequency signal Sf according to the obtained coordinate location. At this time, the second antenna loops 230b and 230c are not enabled to operate. Thereby, the efficiency that the digital tablet 200 provides electric power required by the battery-free wireless pointer device 100 is enhanced, and the development of the wireless digital tablets or large-area digital tablets is also facilitated.

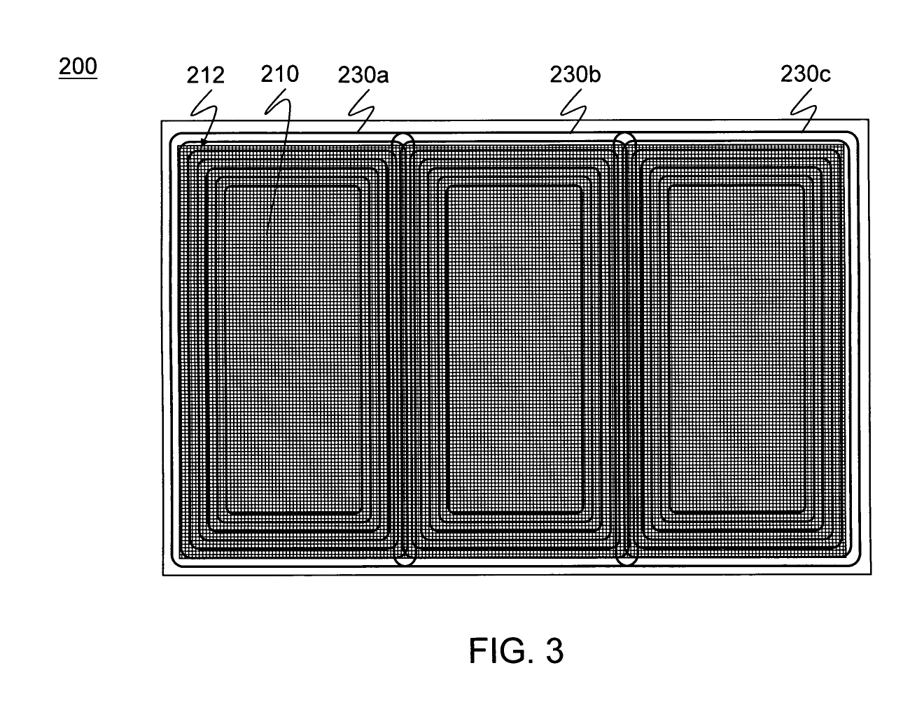

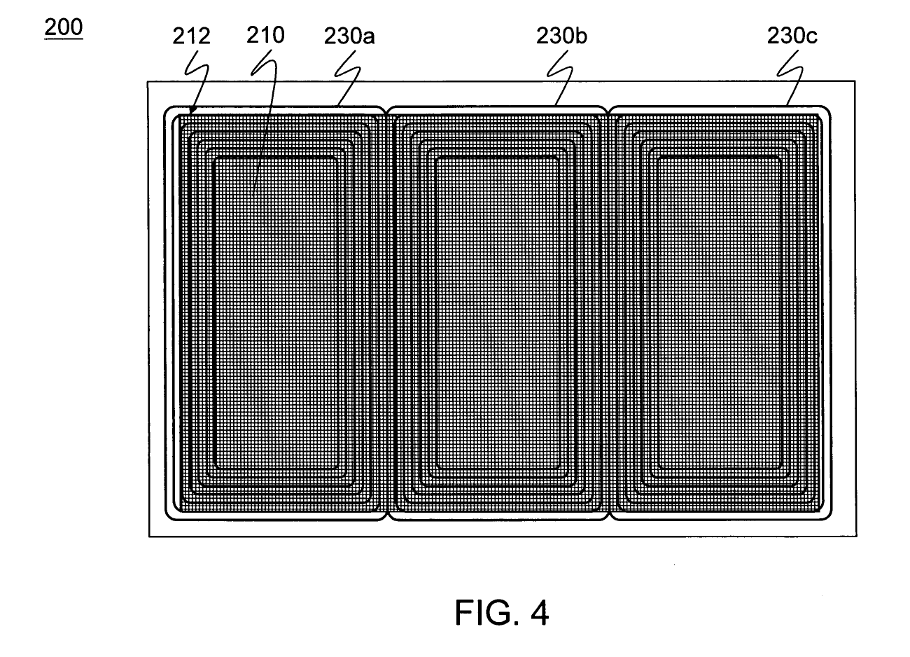

Here, the second antenna loops 230a, 230b, and 230c cover the whole induction zone 212. Moreover, the adjacent second antenna loops 230a, 230b/230b, 230c may be partially overlapped, that is, the edge portions thereof are overlapped, as shown in FIG. 3. In addition, the adjacent second antenna loops 230a, 230b/230b, 230c may also be designed that the edge portions thereof are not overlapped, that is, the edges thereof are abutted, as shown in FIG. 4.

The digital tablet 200 further comprises a control circuit 270.

The control circuit 270 selectively enables the second antenna loops 230a, 230b, and 230c, so that the second antenna loop 230a/230b/230c located on the current coordinate location of the battery-free wireless pointer device 100 transmits the frequency signal Sf.

That is to say, when the digital tablet 200 and the battery-free wireless pointer device 100 are signal-connected, for the second antenna loops 230a, 230b, and 230c, the control circuit 270 only enables the second antenna loop 230a/230b/230c located on the current coordinate location of the battery-free wireless pointer device 100, so that only the enabled second antenna loop 230a/230b/230c transmits the frequency signal Sf.

The control circuit 270 may select the second antenna loop 230a/230b/230c to be enabled by controlling power supply status of the second antenna loops 230a, 230b, and 230c. In other words, the control circuit 270 may select and enable one of the second antenna loops 230a, 230b, and 230c by controlling whether to supply power or not. It can be understood that, the control circuit 270 may also select and enable a plurality of adjacent second antenna loops, for example, select the second antenna loops 230a and 230b at the same time, or select the second antenna loops 230b and 230c at the same time.

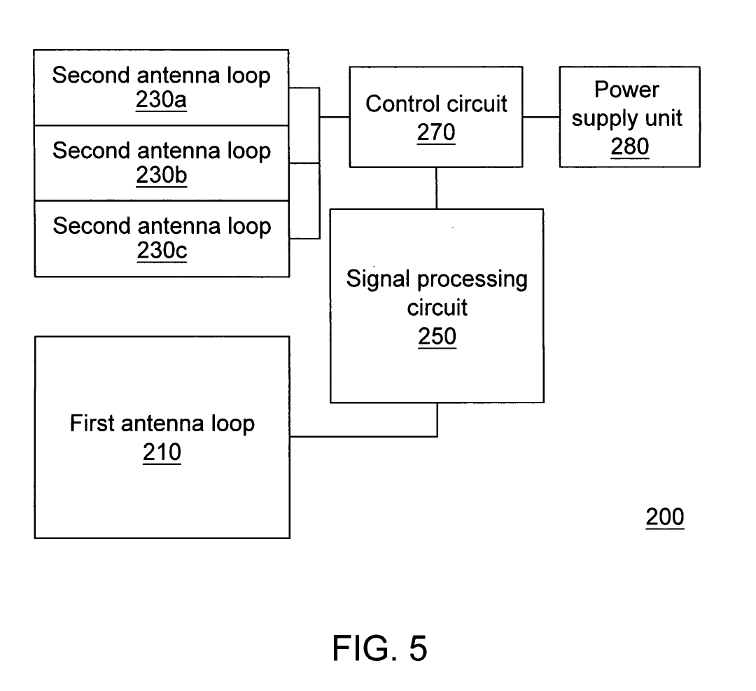

Referring to FIG. 5, the control circuit 270 may control a power supply unit 280 according to the calculated coordinate location, so that the power supply unit 280 supplies power to the second antenna loop 230a/230b/230c located on the current coordinate location of the battery-free wireless pointer device 100 and does not supply power to the second antenna loops that are not located on the current coordinate location of the battery-free wireless pointer device 100. Therefore, only the second antenna loop 230a/230b/230c located on the current coordinate location of the battery-free wireless pointer device 100 transmits the frequency signal Sf.

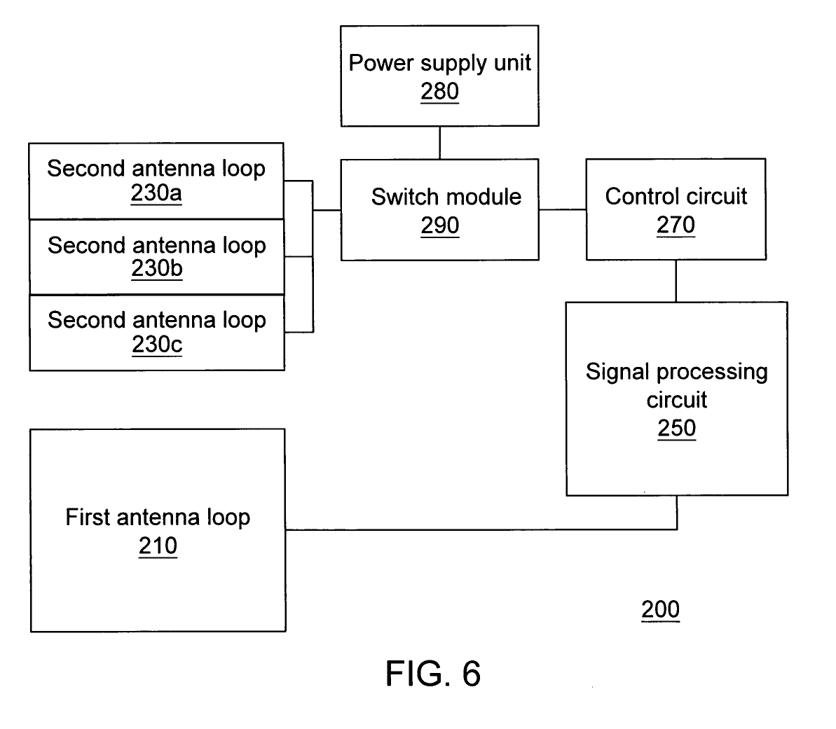

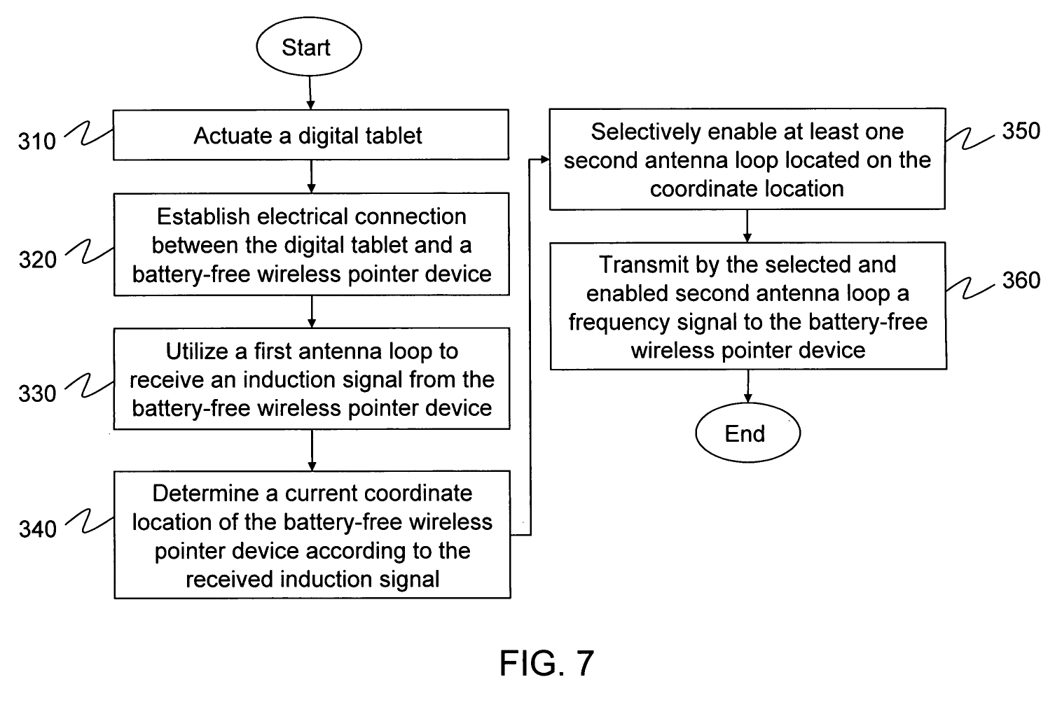

Moreover, referring to FIG. 6, a switch module 290 is disposed between the control circuit 270 and the second antenna loops, so as to switch the power according to the calculated coordinate location. Here, the switch module 290 connects the power supply unit 280 to each second antenna loop 230a/230b/230c. The control circuit 270 is electrically connected to the switch module 290. The control circuit 270 may control the switch module 290 according to the calculated coordinate location to conduct a power supply path between the power supply unit 280 and the second antenna loop 230a/230b/230c located on the current coordinate location of the battery-free wireless pointer device 100, and does not conduct the power supply path between the power supply unit 280 and the second antenna loop 230a/230b/230c not located on the current coordinate location of the battery-free wireless pointer device 100. Therefore, only the second antenna loop 230a/230b/230c located on the current coordinate location of the battery-free wireless pointer device 100 transmits the frequency signal Sf. It can be understood that, a plurality of adjacent second antenna loops on the current coordinate location of the corresponding battery-free wireless pointer device 100, for example, the second antenna loops 230a and 230b, or the second antenna loops 230b and 230c, may also be adopted to transmit the frequency signal Sf. Referring to FIG. 7, a power supply method for the digital tablet for battery-free wireless pointer device is applied in a digital tablet used in combination with a battery-free wireless pointer device. The digital tablet at least comprises a first antenna loop and a plurality of second antenna loops.

The power supply method of the digital tablet for battery-free wireless pointer device comprises the following steps.

A first antenna loop is utilized to induce a battery-free wireless pointer device so as to receive an induction signal from the battery-free wireless pointer device wirelessly (Step 330).

A signal processing circuit is provided to determine a current coordinate location of the battery-free wireless pointer device according to the received induction signal (Step 340).

A control circuit is provided to selectively enable at least one second antenna loop located on the coordinate location among a plurality of second antenna loops covering the first antenna loop (Step 350).

The selected and enabled second antenna loop is provided to wirelessly transmit a frequency signal, so that the battery-free wireless pointer device obtains an electric power by forming electromagnetic resonance according to the frequency signal (Step 360).

When no current coordinate location of the battery-free wireless pointer device is available, all the second antenna loops are enabled or the second antenna loops are enabled in sequence, so that the battery-free wireless pointer device and the first antenna loop of the digital tablet are electrically connected.

For example, when the digital tablet is actuated (Step 310), all the second antenna loops are first enabled or the second antenna loops are enabled in sequence, so that the second antenna loops (enabled) transmit the frequency signal. On receiving the frequency signal, the battery-free wireless pointer device obtains the electric power through electromagnetic resonance of the frequency signal, and is actuated to generate an induction signal. Thereby, the first antenna loop of the digital tablet induces and obtains the induction signal, so as to be electrically connected to the battery-free wireless pointer device (Step 320), and the digital tablet is enabled to calculate the current coordinate location of the battery-free wireless pointer device through the induction signal.

Alternatively, when the digital tablet is actuated, the digital tablet may also enable the second antenna loops one by one or enable the second antenna loops alternately (for example, the second antenna loops located on odd-numbered and even-numbered locations are alternately enabled).

Here, the second antenna loops to be enabled are determined by controlling the power supply of the second antenna loops. In other words, the electric power is provided to the second antenna loops located on the coordinate location according to the calculated coordinate location and not provided to the second antenna loops not located on the coordinate location. It can be understood that, the electric power may also be provided to a plurality of adjacent second antenna loops on corresponding coordinate locations according to the calculated coordinate location.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A digital tablet for battery-free wireless pointer device, comprising:
a battery-free wireless pointer device, at least comprising:
a power supply circuit, having a plurality of induction coils, for utilizing the plurality of induction coils to receive a frequency signal sent by a digital tablet wirelessly, and forming electromagnetic resonance through the frequency signal to produce an electric power; and
an induction circuit, for receiving the electric power produced by the power supply circuit and generating an induction signal to be transmitted to the digital tablet; and
a digital tablet, at least comprising:
a signal processing circuit, for generating a frequency signal, and calculating a current coordinate location of the battery-free wireless pointer device according to the induction signal sent by the battery-free wireless pointer device;
a first antenna loop, forming an induction zone for inducing the battery-free wireless pointer device, so as to induce the battery-free wireless pointer device to receive the induction signal wirelessly;
a plurality of second antenna loops, located on the induction zone, for transmitting the frequency signal; and
a control circuit, located between the signal processing circuit and the plurality of second antenna loops, for enabling at least one of the plurality of second antenna loops to transmit the frequency signal according to the coordinate location of the battery-free wireless pointer device.

2. The digital tablet for battery-free wireless pointer device according to claim 1, wherein the digital tablet further comprising:
a switch module, located between the control circuit and the plurality of second antenna loops.

3. The digital tablet for battery-free wireless pointer device according to claim 1, wherein the plurality of second antenna loops covers the whole induction zone in an edge-overlapping or edge-abutting manner.

4. The digital tablet for battery-free wireless pointer device according to claim 1, wherein the battery-free wireless pointer device is a wireless cursor pen or a wireless mouse.

5. A digital tablet, for inducing a battery-free wireless pointer device, at least comprising:
a first antenna loop, forming an induction zone, for receiving an induction signal from the battery-free wireless pointer device wirelessly;
a signal processing circuit, for calculating a current coordinate location of the battery-free wireless pointer device according to the induction signal received by the first antenna loop and generating a frequency signal;
a plurality of second antenna loops, located on the induction zone, for being selected to transmit the frequency signal selectively according to the calculated coordinate location; and
a control circuit, for enabling at least one of the plurality of second antenna loops to transmit the frequency signal selectively according to the coordinate location.

6. The digital tablet according to claim 5, further comprising:
a switch module, disposed between the control circuit and the second antenna loops.

7. A power supply method of a digital tablet for battery-free wireless pointer device, comprising:
utilizing a first antenna loop to induce a battery-free wireless pointer device so as to receive an induction signal from the battery-free wireless pointer device wirelessly;
providing a signal processing circuit to determine a current coordinate location of the battery-free wireless pointer device according to the received induction signal;
providing a control circuit to selectively enable at least one of a plurality of second antenna loops covering the first antenna loop selectively according to the coordinate location; and
providing the selected and enabled second antenna loop to wirelessly transmit a frequency signal, so that the battery-free wireless pointer device obtains an electric power by forming electromagnetic resonance according to the frequency signal.

8. The power supply method of the digital tablet for battery-free wireless pointer device according to claim 7, further comprising:
enabling all the second antenna loops first when the battery-free wireless pointer device is located on the first antenna loop, so that the battery-free wireless pointer device and the first antenna loop are electrically connected and the induction signal is obtained.

9. The power supply method of the digital tablet for battery-free wireless pointer device according to claim 7, further comprising:
enabling the plurality of second antenna loops in sequence first when the battery-free wireless pointer device is located on the first antenna loop, so that the battery-free wireless pointer device and the first antenna loop are electrically connected and the induction signal is obtained.
